(19) United States
(12) Patent Application Publication
(10) Pub. No.: US 2010/0017374 A1
(43) Pub. Date: Jan. 21, 2010

(54) APPROCHING CONTROL SYSTEM TO THE FILE SERVER

(76) Inventors: Hwan Kuk Bae, Seoul (KR); Yang Jin Seo, Seoul (KR); Sang Hak Nah, Seoul (KR); Sang Jin Kim, Seoul (KR)

Correspondence Address: IPLA P.A., 3580 WILSHIRE BLVD., 17TH FLOOR, LOS ANGELES, CA, 90010, US

(21) Appl. No.: 12/518,871

(22) PCT Filed: Dec. 11, 2007
(86) PCT No.: PCT/KR2007/006450

§ 371 Date: Jun. 11, 2009

(30) Foreign Application Priority Data
Dec. 11, 2006 (KR) 10-2006-0125837
Dec. 11, 2007 (KR) PCT/KR2007/006450

(51) Int. Cl. G06F 7/10; G06F 17/30

(52) U.S. Cl. 707/3; 707/9; 707/E17.108; 707/E17.005; 707/E17.01

(57) ABSTRACT

A system for controlling access to a file server is disclosed. The system for controlling access to a file server includes a management server, a plurality of client terminals for communicating with the management server, and a file server for storing one or more documents shared by the plurality of client terminals. Each of the client terminals includes a file server access module for verifying a user, and a security explorer tool driving module for outputting one or more documents stored in the file server. The management server includes an authorized user information database for storing authentication information, a user verification module for checking user information and searching for authentication information, and a document classification module for searching the file server for documents within the authorization limits based on the user, and transmitting the found documents to the security explorer tool driving module, thereby restricting documents depending on the users.

### TECHNICAL FIELD

The present invention relates to an access control system for controlling the access of a plurality of terminals or users to a file server, which enables the plurality of terminals or users to share various types of information documents, such as drawing files, image files, text files, moving image files and Musical Instrument Digital Interface (MIDI) files.

### BACKGROUND ART

Since various types of information documents (hereinafter referred to as “documents”), such as drawing files, image files, text files, moving image files, and MIDI files, which are utilized in enterprises and government offices, must be able to be accessed and utilized by a plurality of users having relationships with the enterprises and government offices, the documents are stored in a file server and are then shared in an environment in which a plurality of client terminals is connected via the Web or a network.

FIG. 1 is a view showing communication between a management server, a file server and terminals in a Web or network environment. The following description will be given with reference to this drawing.

A system that is configured such that a plurality of users shares information while communicating with each other mainly includes a plurality of client terminals 30, 30′, and 30″ which communicate with each other via the Web or a network, and a management server 10 which is connected to the client terminals 30, 30′, and 30″ while managing the communication therebetween.

The management server 10 can control the communication between the client terminals 30, 30′, and 30″ and supervise communication with the outside for the purpose of security, and can store necessary documents and then provide documents in response to the request of the client terminals 30, 30′, and 30.″ Since the construction of the management server 10 is part of a widely-known conventional system, an additional description thereof will be omitted here.

Meanwhile, as the amount of information increases and the management thereof is considered more important, the specialized management of information has been required. Therefore, for conventional functions of the management server 10, a file sharing server 20 (hereinafter referred to as a file server) manages the operation of storing and managing information, and the management server 10 performs only the operations of performing communication control and security between the client terminals 30, 30′, and 30″.

However, the file server 20 may contain important confidential information, which must not be open to the public, in the documents thereof, in addition to information which can be open to the public. Therefore, in order to prevent the illegal leakage of confidential information, access to the file server, which contain confidential information in the documents thereof, can be made only through authorized client terminals 30, 30′, and 30″, so that the documents can be viewed only in the corresponding client terminals 30, 30′, and 30″.

Here, the term “view” collectively refers to ‘retrieving a document’, ‘viewing a document’, ‘editing a document’, and ‘transferring a document’.

However, in the conventional security method, access to the file server 20 can be made through the authorized client terminals 30, 30′, and 30″, and there is no difficulty of leaking stored documents after the access has been made. Furthermore, since no accurate data or evidence for the leaked documents remains, a problem occurs in that it is difficult to chase the user responsible for leaking the documents and the reliability of the results of the chase is low. In consequence, the conventional security method for a file server has a structure in which security for corresponding documents is determined depending on the awareness and determination of users who are authorized to access the file server 20.

That is, since the security of a network, including the management server 10, the file server 20, and the client terminals 30, 30′, and 30″, is determined depending on the intention of users, the reliability of security is low.

Meanwhile, the conventional document sharing method of a file server has a problem in that the use of the file server is considerably inconvenient because an access process performed at the time of access to the file server 20 through the authorized client terminals 30, 30′, and 30″ is complicated and the method of searching for necessary documents is not familiar to users.

### DISCLOSURE

### Technical Problem

Accordingly, the present invention has been made keeping in mind the above problems occurring in the prior art, and an object of the present invention is to provide a system for controlling access to a file server that can make access to or the use of documents, stored in a file server shared by a plurality of client terminals, easy, and can provide high security efficiency, thereby enabling the more secure and effective use of the shared documents.

### Technical Solution

In order to accomplish the above object, the present invention provides a system for controlling access to a file server, including a management server, a plurality of client terminals for communicating with the management server, and a file server for storing one or more documents shared by the plurality of client terminals, wherein: each of the client terminals includes a file server access module for verifying a user who attempts to access the file server, and a security explorer tool driving module for outputting one or more documents stored in the file server if the file server access module determines that the user has been authorized to access the file server; and the management server includes an authorized user information DataBase (DB) for storing authentication information about possibility of access to the file server and authorization limits of users, a user verification module for checking user information from the file server access module, and searching for authentication information stored in the authorized user information DB, and a document classification module for searching the file server for one or more documents within the authorization limits based on the user using authentication information from the user identification module, and transmitting the found documents to the security explorer tool driving module, thereby restricting documents, which will be shown by the security explorer tool driving module through the client terminal, depending on the users.

### Advantageous Effects

According to the above-described present invention, a system, in which a management server communicates with a plurality of client terminals, and a file server for storing various types of documents communicates with the management server and the client terminals while the documents stored in the file server are shared, is provided. At the time of accessing a file server through a plurality of client terminals, the authorization limits of access to shared documents are discriminated for respective users, so that there is an effect in that document security can be managed in detail.

Furthermore, since a necessary document can be opened or searched for using a dedicated security explorer tool at the time of accessing a file server, the user can have the sensation of working in a local area, so that there is an effect in that the user can perform more stable and efficient document work.

Furthermore, since information files are provided in respective documents, requiring security, or documents are collected in a document DB, and then access to the documents is controlled and managed for respective users, there is the weak possibility of collision or corruption of a relevant document when two or more users simultaneously perform work on the same document, so that more secure document work can be conducted.

### DESCRIPTION OF DRAWINGS

FIG. 1 is a view showing a communication state between a management server, a file server, and terminals in a Web or network environment;

FIG. 2 is a block diagram showing the construction of FIG. 1 in detail based on an access control system according to the present invention;

FIG. 3 is a flowchart of a process of accessing documents using the access control system according to the present invention and viewing the documents in steps;

FIG. 4 shows an image in which the selection menu option of a file server security explorer tool according to the present invention is posted on the Graphic User Interface (GUI) of Windows™;

FIG. 5 shows a GUI image which shows the driving state of the file server security explorer tool according to the present invention; and

FIG. 6 is a block diagram showing an access control system according to another embodiment of the present invention.

### MODE FOR INVENTION

The present invention will be described in detail below with reference to the accompanying drawings.

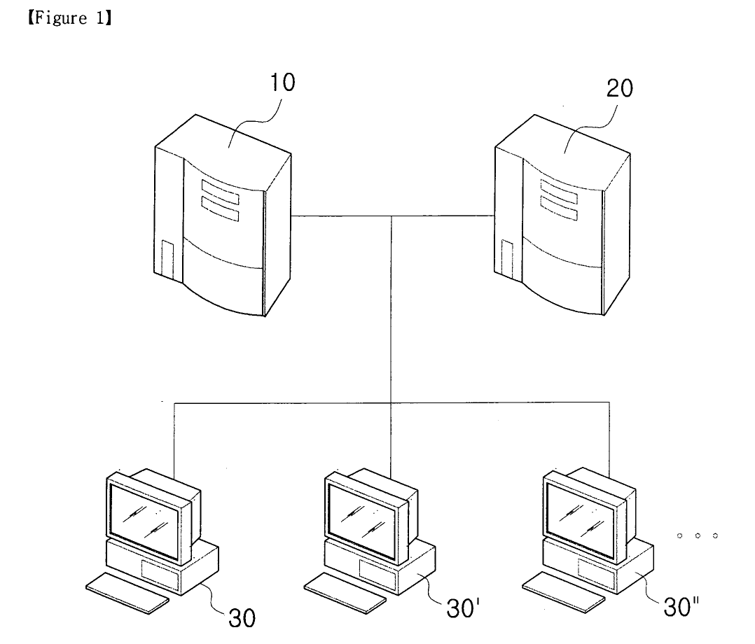

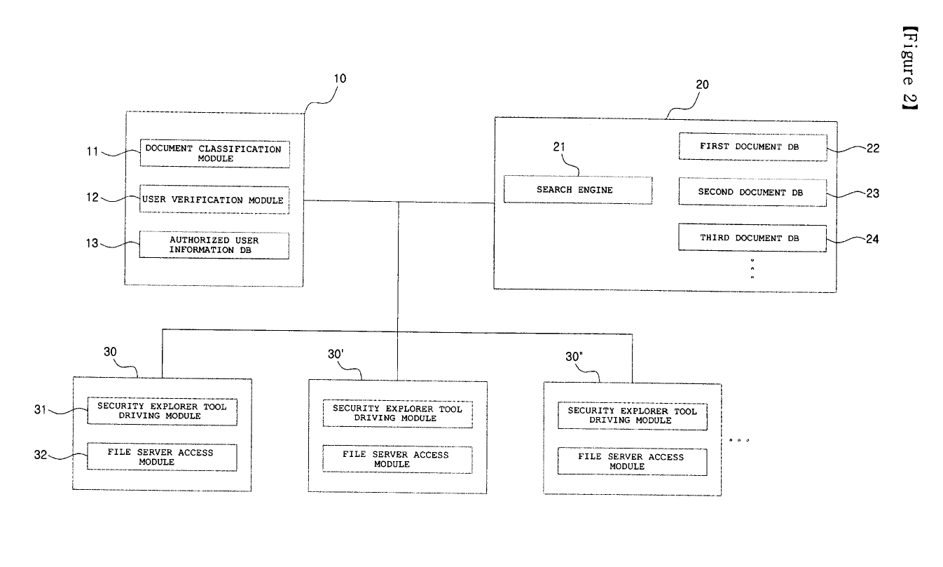

FIG. 2 is a block diagram showing the construction of FIG. 1 in detail based on an access control system according to the present invention. The following description will be given with reference to this drawing.

The access control system according to the present invention is installed in or is applied to a structure in which a management server 10, a file server 20 and a plurality of client terminals 30, 30′ and 30″, which are connected to the management server 10 and the file server 20 and communicate with each other via the Web or a network environment, are included, and functions to control the access of the client terminals 30, 30′, 30″ to the file server 20, and manage the viewing of documents stored in the file server 20.

For this purpose, the management server 10 includes a user verification module 12 for identifying the users of the client terminals 30, 30′, and 30″, an authorized user information DataBase (DB) 13 for storing the information of the users, and a document classification module 11 for searching for and classifying documents that are provided distinctively for respective users.

Meanwhile, the file server 20 includes one or more document DBs for storing documents, and a search engine 21 for managing/searching the document DBs. Here, the document DB may include a plurality of document DBs when necessary.

For reference, such a document DB includes a plurality of DB drives from the point of view of hardware, and is then divided into a first document DB 22, a second document DB 23, a third document DB 24 and so on. In a single drive device, the area of a disk is divided, and is then classified into a first document DB 22, a second document DB 23, a third document DB 24 and so on. The concept of a virtual disk may be applied to the latter case, which will be described in detail below.

Thereafter, the client terminal includes a plurality of client terminals 30, 30′, and 30″, as shown in the drawing. Each of the terminals includes a security explorer tool driving module 31 for controlling the operation of the security explorer tool, which manages the access control system according to the present invention, and a file server access module 32 for functioning as a procedure performing device which determines whether access to the file server 20 is authorized.

For easier comprehension of the technical scope of the access control system according to the present invention, an overall process of users accessing the file server 20 using the respective client terminals 30, 30′, and 30″, and viewing documents stored in the file server 20, is described.

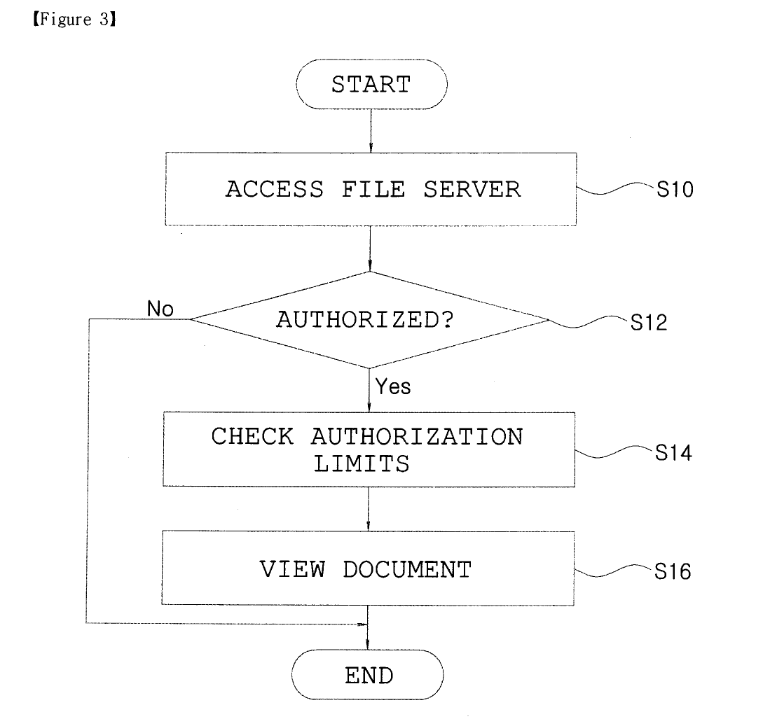

FIG. 3 is a flowchart showing the process of accessing the documents using the access control system according to the present invention and viewing the documents in steps. The following description will be given with reference to this drawing.

S10; File Server Access Step

A user accesses the file server 20 via one of the client terminals 30, 30′ and 30″. Here, the client terminals 30, 30′ and 30″ may communicate with the file server 20 via the Web or a restricted network such as a mobile local area network.

Although, in the embodiment of the present invention, communication between the client terminals 30, 30′ and 30″, the management server 10 and the file server 20 is performed using the latter communication network, which is not accessible to external persons, the technical spirit of the present invention is not limited thereto.

The method by which a user accesses the file server 20 via one of the client terminals 30, 30′ and 30″ is various. However, the control system according to the present invention adopts the configuration of Windows™ Explorer in order to access the file server 20.

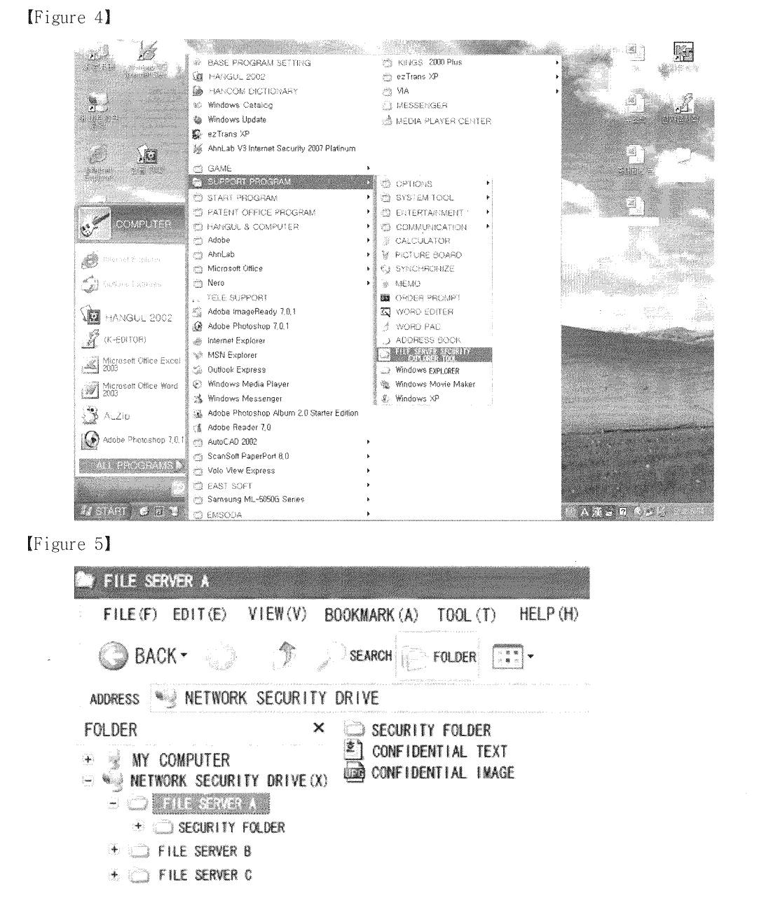

That is, as shown in FIG. 4 (an image that shows a menu option for a file server security explorer tool according to the present invention, which is posted on the GUI of Windows™), the “file server security explorer tool” of the control system according to the present invention is posted near “Windows Explorer”, so that the users of the client terminals 30, 30′ and 30″ can perform work with a sensation like the sensation of searching for and opening documents in local PC client terminals.

Furthermore, the security explorer tool according to the present invention may be implemented using a d11 module, such as ‘Shell name extension’ or ‘ActiveX’, besides the method like that of “Windows Explorer.”

Meanwhile, access to the file server 20 is not uniformly authorized without discrimination between the client terminals 30, 30′ and 30″. That is, one client terminal 30 may access the file server 20, and the other client terminals 30′ and 30″ may not access the file server 20. This can be made possible by installing a file server access module 32, including an authorization file, in the client terminal 30 that is permitted to access the file server 20.

The menu option of the “file server security explorer tool” can be seen in the client terminal 30 in which the file server access module 32 is installed, as shown in FIG. 4, while the menu option cannot be seen in the client terminals 30′ and 30″ in which the file server access module 32 is not installed.

However, since this is merely one of various embodiments related to whether the menu option of the “file server security explorer tool” can be seen, the technical spirit of the present invention is not limited thereto (the “file server security explorer tool” may not be executed in the client terminal 30 that cannot access the file server even when the “file server security explorer tool” is seen).

S12; Authorization Verification Step

When a user selects the menu option of the “file server security explorer tool,” the file server access module 32 checks whether a currently running client terminal 30, 30′ or 30″ has been authorized while communicating with the management server 10.

Thereafter, if the client terminal 30 is determined to be an authorized terminal, the file server access module 32 outputs an ID/password input window to the client terminal 30 so as to verify whether the user has been authorized.

However, the present invention is not limited thereto. That is, (1) whether to activate the security explorer tool may be determined by directly outputting an ID/password input window for verifying whether a user has been authorized and verifying whether the user has been authorized using an ID/password input through the input window without verifying whether the client terminal 30, 30′ or 30″ has been authorized, and (2) whether to activate the security explorer tool may be processed by executing the security explorer tool in an authorized client terminal 30, 30′ or 30″ without verifying the authorization of a user in such a way that the file server verifies whether the accessing client terminal 30, 30′ or 30″ has been authorized.

In the latter case, when an unauthorized client terminal 30, 30′ or 30″ attempts to execute the security explorer tool, a window showing a sentence, such as “access is denied,” is output, thereby informing the user of the impossibility of access to the security explorer tool.

Although the authentication process may be implemented in various embodiments, the technical spirit of the present process will be described through an embodiment using an ID and a password. Of course, the technical spirit of the present invention may be modified and practiced in various manners within a range that does not depart from the attached claims.

When the user inputs his or her ID and password to the input window, the file server access module 32 sends the authentication information (ID/password) to the user verification module 12 of the management server 10.

The user verification module 12 searches authorization information DB 13 for information identical to the authentication information.

The authorization information DB 13 may contain various types of personal information, including users' authentication information, and the user verification module 12 checks whether the user who attempts to access the file server 20 is a user who has been authorized to access the file server 20 using the authentication information.

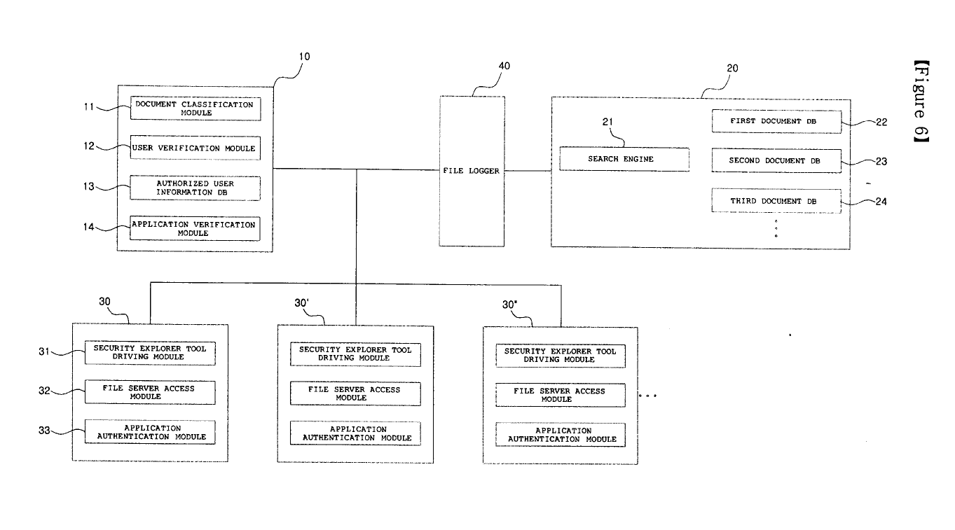

If, as a result of the authentication by the user verification module 12, the user is determined to be an unauthorized user, the user's access to the file server 20 is denied. In contrast, if the user is an authorized user, the user verification module 12 sends a driving signal to the security explorer tool driving module 31. As a result, the security explorer tool driving module 31 activates the file server security explorer tool according to the present invention, and thus the user can access/search the file server using a method similar to a method of using the well-known Windows Explorer, as shown in FIG. 5 (an image showing a GUI that shows the operation of the file server security explorer tool according to the present invention).

In the shown embodiment, a ‘network security drive’, which is a directory for the file server 20, is found through the security explorer tool, and a plurality of file servers A to C is included in the ‘network security drive’. The file servers A to C refer to the first, second and third document DBs 22, 23 and 24, respectively. Depending upon the authentication of a user, information about all or part of the file servers A to C may be output. Through this, the user can access a relevant first, second or third document DB 22, 23 or 24 by clicking on information about only a relevant file server.

Of course, since a user who has not been authorized for access to the file server 20 cannot find the ‘network security drive’ itself through the security explorer tool, it is impossible for the user to access the file server 20.

S14; Authorization Limits Checking Step

As described above, the control system according to the present invention may discriminate between accessible documents even for respective users who have been authorized for access to the file server 20.

Of course, it is possible to show all the documents of a relevant file server 20 to a user who has succeeded in accessing the file server 20, and to determine whether the user has been authorized to view a relevant document and to then open the document or deny the viewing of the document when the user selects one from among the documents and attempts to view the document. However, in the embodiment of the present invention, documents output to the file server security explorer tool are initially discriminated between for respective users and then output.

That is, a user can view all documents the information of which is output to the file server security explorer tool.

For this purpose, in the present invention, the management server 10 further includes a document classification module 11.

The document classification module 11 checks a relevant user's rights by searching the authorization information DB 13 in the user verification process, which is conducted in the 12, extracts accessible documents corresponding to the rights by searching the first, second and third document DBs 22, 23 and 24 using the search engine 21 of the file server 20, and sends information about the resulting documents to the client terminal 30 in conjunction with the operation of the security explorer tool driving module 31.

Since the authorization limits for viewing of documents may be different for respective users in the same department having a team including a plurality of users through the above-described classification of documents for respective users, there is an advantage in that the security of the documents in the file server 20 can be defined in detail.

Meanwhile, in order to check a user's authorization limits for viewing of documents and allow the user to access and view the documents within the authorization limits, the storage device of the file server 20 may be implemented in various embodiments. The respective embodiments will be disclosed below.

A plurality of first, second and third document DBs 22, 23 and 24 may be established in the file server 20, and the first, second and third document DBs 22, 23 and 24 may store documents that have been classified according to security level. That is, the document classification module 11 checks the authorization limits of a relevant user, and opens only one or more relevant document DBs. As a result, only the documents of the opened document DBs are opened to the user's client terminal 30 through the security explorer tool.

Furthermore, an information file, in which data about a security level is recorded, is created for each document, so that only documents corresponding to a relevant user may be searched for and be opened to the user's client terminal 30.

However, the method in which the control system according to the present invention opens documents only to the client terminal 30, 30′ or 30″ is merely an embodiment, but a method of opening all documents regardless of users and client terminals 30, 30′ and 30″ and allowing viewing to be performed within the authorization limits of the users and the client terminals 30, 30′ and 30″ may also be employed.

However, the application of the concept of a virtual disc to the file server 20 is only an embodiment for implementing the file server 20, which is part of the system according to the present invention, and the following embodiments, other than the application of the concept of a virtual disc, can be realized.

The file server 20 has the same structure as a typical conventional file server, verifies a client terminal 30, 30′ or 30″ or a user through the user verification module 12, and allows only an authorized client terminal 30, 30′ or 30″ or an authorized user to access the file server 20. Therefore, an indication of a drive, showing the file server 20, is output to a given client terminal 30, 30′ or 30″ regardless of whether authorization has been permitted, thus allowing the user to be aware of the presence of the file server 20 through the indication of the drive. When an authorized user attempts to access the file server 20, the access is permitted, whereas, when an unauthorized user attempts to access the file server 20, a window showing a message, such as “access is rejected” is output, thereby notifying the current user that access to the security explorer tool is impossible.

However, it is also possible to prevent an unauthorized user from being aware of the presence of the file server 20 itself by differently setting an indication of a drive through the client terminals 30, 30′ and 30″ according to whether authorization has been granted.

An embodiment in which a virtual disk is applied to the file server 20 according to the present invention will be described below.

Since the concept of a virtual disk is described in detail in “Access Control System for Respective Application Programs using Virtual Disk and Method of Controlling the Same (Korean Patent No. 10-0596135)” which was filed and the patent rights of which is possessed by the present applicant, a description of a virtual disk will be omitted. A description of the application of the virtual disk to the present invention will be described below.

A virtual disk, defined in “Access Control System for Respective Application Programs using Virtual Disk and Method of Controlling the Same (hereinafter referred to as ‘prior art invention’)”, is installed in a hard disk (although a hard disk is considered to be a simple data storage recording device in a general-purpose local PC, the hard disk may be called a DB and may be considered to be a DB in the case of a server connected to clients via a network or the Internet. Therefore, in the present invention, a hard disk, which is a space to which a virtual disk is applied, includes not only the hard disk of a general-purpose PC but also the DB of a server. Here, the DB is a file server), and is configured to classify applications that attempt to access the virtual disk into an authorized application module and an unauthorized application module and controls the access of the application modules. In the present invention, a virtual disk is installed in the file server, and whether the client terminals and users that attempt to access the file server have been authorized is checked, thereby controlling access to the file server.

That is, when the security explorer tool driving module 31 verifies a user and then drives the security explorer tool, only one or more virtual disk drives corresponding to the authorization limits of the verified user are output within the security explorer tool so as for the user to access them. Of course, in the case in which the user's authorization limits for access does not include a specific virtual disk drive, the security explorer tool does not output the virtual disk drive.

In brief, if, in the prior art invention, for example, a security file stored in a virtual disk should be retrieved so as for an authorized application to perform work, the authorized application can detect the security file by executing a retrieval function (the case of a Windows system is an example). Since this is a retrieval function executed by the authorized application, the security file is considered to be a file stored in a separate drive (the virtual disk is recognized as a separate drive by the Operating System (OS)) and is easily found and retrieved. However, in the case of an unauthorized application, the security file cannot be retrieved even if the retrieval function is executed because the corresponding drive does not exist as a target for retrieval. That is, the OS recognizes the virtual disk not as a separate drive but as a single file.

As described above, the system for controlling access to a file server according to the present invention includes a plurality of virtual disks, and classifies them into first, second, third document DBs 22, 23, and 24, and verifies the authorization limits of a user who attempted access, so that only the document DBs authorized for the corresponding user are recognized as independent drives in the security explorer tool.

Meanwhile, after a user accesses a document DB, the user can store one or more documents stored in the document DB using respective ‘other names’ while viewing the documents. That is, the documents can be stored in another document DB or in a user's client terminal 30, 30′, or 30″, which is a local area, instead of the file server 20.

This also can be restricted using a virtual disk function. That is, the user, who retrieves a document from the first document DB 22 and is performing work on it, can retrieve documents stored in the second and third document DBs 23 and 24 (in the case in which the corresponding user has been authorized to access documents stored in the second and third document DBs) and view them, but cannot edit or store them. Of course, the user can retrieve the stored documents to his or her client terminal, which is a local area and view them, but cannot edit or store them.

Therefore, after the user closes the document of the first document DB 22 and then disconnects the first document DB 22, the user can retrieve other documents from the second and third document DBs 23 and 24, and then can view, edit, or store them.

S16: Document Viewing Step

A user accesses the file server through the file server security explorer tool, and views one or more desired documents.

If access to the file server 20 has been authorized, the user is authorized to view one or more documents stored in the document DB. Here, the view is classified as view which allows only ‘opening a document’, as view which allows ‘opening a document’ and ‘editing a document’, and as view which allows ‘opening a document’, ‘editing a document’, and ‘transferring a document’. That is, for the same document, the usage methods thereof can be divided according to the authorization limits of respective users.

For this purpose, the authorization limits of respective users for documents are also recorded in the authorized user information DB 13. When a document is provided to a user, an information file is associated with the document based on the record of the corresponding user, so that the user can view and process the document according to on his or her authorization limits.

Thereafter, when a plurality of users simultaneously attempts to access a document, stored in the file server, through different client terminals 30, 30′, and 30″, the system for controlling access to a file server according to the present invention performs processes of verifying whether the user has been authorized to access the document and encrypting/encrypting the corresponding document at the level of a document DB, which stores the document, rather than at the level of an individual document. Therefore, even if the plurality of users attempts to access a single document, the possibilities of collision for document processing between users, damage to the document attributable to the collision, and incorrect operation attributable to the performance of encryption/decryption are minimized, thereby realizing a more stable system.

That is, the file server according to the present invention stores documents in a general file form, on which encryption is not performed, but performs encryption only on a process of accessing the file server. Therefore, when an authorized client terminal or a user attempts access, and thus connection between the file server and the authorized client is realized, the authorized client terminal or the user can access and view necessary documents as usual, as when viewing documents, without performing a separate procedure or process.

FIG. 6 is a block diagram showing an access control system according to another embodiment of the present invention. The following description will be given with reference to this drawing.

The access control system according to the present invention further includes a file logger 40.

The file logger 40 stores the history of viewing of a document when a user accesses the file server 20 and views the document. That is, the file logger 40 records a user, a client terminal 30, 30′ or 30″ used by the user, the time at which access to the file server was made, a viewed document, and a document DB in which the document is stored.

Further, when a document stored in a document DB is viewed by a user and then the information of the document is newly updated through an editing process or the like, an original document, which is not updated, is stored in the file logger 40 so as to preserve the original of the corresponding document.

The record in the file logger 40 is used as information which is used for post inspection or is used to detect a leakage path when a document is leaked.

Meanwhile, a system for controlling access to a file server according to another embodiment of the present invention includes an application authentication module 33 for verifying whether an application that opens one or more documents stored in the file server 20 has been authorized, and an application verification module 14 for verifying whether an application, installed in a currently accessed client terminal 30, 30′, or 30″, has been authorized while communicating with the application authentication module 33.

For example, even if a client terminal 30, 30′ or 30″, in which a Computer-Aided Design (CAD) program (application) capable of executing a “*.dwg” format file (document) is installed, can normally access the corresponding file server 20 and view the “*.dwg” format file, the corresponding “*.dwg” format file cannot be opened if the CAD program has not been authorized.

For this purpose, an authentication file is installed in an application authorized to access the file server 20, and an authentication verification file corresponding to the authentication file is installed in the application verification module 14. When an arbitrary application is run, whether the application has been authorized to access the file server 20 is verified. If, as the result of the verification of the application verification module 14, it is determined that the corresponding application has been authorized to access the file server 20, the security explorer tool driving module 31 is run normally and thus allows a user to search the file server 20 for documents.

Even when encryption/decryption is performed on a document stored in the file server 20 at the level of a document rather than at the level of a document DB, the operation of encrypting/decrypting the document is performed without requiring additional operation by the users in the case in which an authorized client terminal 30, an authorized user, and an authorized application attempt to open the corresponding document. Therefore, a problem of collision between operations, attributable to the encryption/decryption of respective users, can be solved even if two or more users simultaneously access and attempt to open a corresponding document.

1. A system for controlling access to a file server, comprising a management server, a plurality of client terminals for communicating with the management server, and a file server for storing one or more documents shared by the plurality of client terminals, wherein:
each of the client terminals comprises a file server access module for verifying a user who attempts to access the file server, and a security explorer tool driving module for outputting one or more documents stored in the file server if the file server access module determines that the user has been authorized to access the file server; and
the management server comprises an authorized user information DataBase (DB) for storing authentication information about possibility of access to the file server and authorization limits of users, a user verification module for checking user information from the file server access module, and searching for authentication information stored in the authorized user information DB, and a document classification module for searching the file server for one or more documents within the authorization limits based on the user using authentication information from the user identification module, and transmitting the found documents to the security explorer tool driving module, thereby restricting documents, which will be shown by the security explorer tool driving module through the client terminal, depending on the users.

2. The access control system as set forth in claim 1, wherein:
the client terminal further comprises an application authentication module for reading an authentication file installed in an executable application; and
the management server further comprises an application authentication module for checking the authentication file transmitted from the application authentication module, and controlling execution of the security explorer tool driving module.

3. The access control system as set forth in claim 1, further comprising a file logger for storing information about client terminals and users that have accessed the file server, and storing histories of viewing of documents, stored in the file server, that is performed through accessing client terminals.

4. The access control system as set forth in claim 2, further comprising a file logger for storing information about client terminals and users that have accessed the file server, and storing histories of viewing of documents, stored in the file server, that is performed through accessing client terminals.
